(19) United States
(12) Patent Application Publication
(10) Pub. No.: US 2024/0425730 A1
(43) Pub. Date: Dec. 26, 2024

(54) RESIN COMPOSITION AND APPLICATION THEREOF

(71) Applicant: SHENGYI TECHNOLOGY CO.,LTD., Dongguan (CN)

(72) Inventors: Zengbiao HUANG, Dongguan (CN); Jianlong HUANG, Dongguan (CN); Yanhua ZHANG, Dongguan (CN)

(21) Appl. No.: 18/385,287

(22) Filed: Oct. 30, 2023

(30) Foreign Application Priority Data
Jun. 19, 2023 (CN) 202310723332.1

(51) Int. Cl. C09J 157/00; C08K 5/14; C08K 5/23; C08K 9/06; C09J 11/06

(52) U.S. Cl. CPC C09J 157/00; C08K 5/14; C08K 5/23; C08K 9/06; C09J 11/06; C09J 2301/312; C09J 2301/408

(57) ABSTRACT

The present application provides a resin composition, and the resin composition comprises the following components: (A) a resin containing unsaturated bonds, (B) an initiator, and (C) an inorganic filler which has been subjected to surface treatment by a silane coupling agent; the silane coupling agent contains a structure shown in formula (I). In the present application, the inorganic filler is subjected to surface treatment by a silane coupling agent containing the structure shown in formula (I), which can improve the binding force at the interface between the inorganic filler and the unsaturated resin matrix, and the prepared insulating adhesive film has excellent dielectric properties, good dielectric stability, and a small change amplitude of ΔD_{f} (10 GHz) after HAST, which can be applied to a high-frequency and high-speed printed circuit board prepared by a semi-additive process or additive process.

### CROSS-REFERENCE TO RELATED APPLICATION(S)

This application claims the benefit of and priority to Chinese Patent Application No. 202310723332.1 filed Jun. 19, 2023, the disclosure of which is incorporated herein by reference in its entirety.

### TECHNICAL FIELD

The present application belongs to the technical field of encapsulation adhesive films, and relates to a resin composition and an application thereof.

### BACKGROUND

In recent years, electronic devices have gradually developed towards miniaturization and high performance, and in printed circuit boards, it is expected that stacking layers are multi-layered, micro-fine wiring, high-density and high-reliability. As a technology for manufacturing printed circuit boards, it is known that in the manufacturing method of building up that the insulating layer and the conductor layer are alternately overlapped on the inner substrate, the insulating layer is usually formed by curing the resin composition. In the process of building up, the insulating adhesive film after Desmear treatment is required to have a low arithmetic mean value (Ra) of roughness profile and high chemical copper binding force to meet the process requirements of ultra-fine circuits.

In order to achieve low dielectric properties of the insulating layer, the resin composition are required to select not only the resin with low dielectric properties, but also the inorganic filler with low dielectric loss. In order to meet the performance of the insulating adhesive film such as low CTE and low warpage, more than or equal to 30 wt % of the high-filling inorganic filler is required to use in the resin composition. However, the high-filling inorganic filler will reduce the HAST resistance of the resin system, and the surface treatment of the inorganic filler will also greatly affect the final low dielectric properties and dielectric stable reliability of the resin composition.

CN107022169A discloses a resin composition, and the filler is subjected to surface treatment by using an alkoxysilane compound containing fluorine atoms, reducing the surface roughness of the insulating layer, which can form a conductor layer with sufficient peel strength, and the penetration depth of the plating, embeddability of component and flame retardance are good. However, the dielectric properties and dielectric stable reliability of the resin composition provided by this invention need to be further improved.

Therefore, it is expected to develop an insulating adhesive film with excellent dielectric properties, good dielectric stability and a small change amplitude of ΔD_{f} (10 GHZ) after HAST in this field, which can be applied to a high-frequency and high-speed printed circuit board prepared by a semi-additive process or additive process.

### SUMMARY

In view of the shortcomings of the prior art, an object of the present application is to provide a resin composition and an application thereof.

To achieve the object, the present application adopts the technical solutions below.

In a first aspect, the present application provides a resin composition, and the resin composition comprises the following components: (A) a resin containing unsaturated bonds, (B) an initiator, and (C) an inorganic filler which has been subjected to surface treatment by a silane coupling agent:
the silane coupling agent contains a structure shown in formula (I):

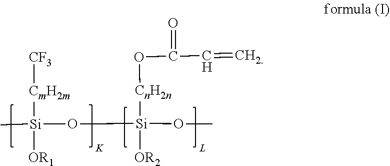

In formula (I), R₁ and R₂ are each independently selected from methyl or ethyl, m and n are each independently selected from integers from 1 to 4 (such as 1, 2, 3 or 4), and K and L are each independently selected from integers from 1 to 30 (such as 1, 3, 5, 8, 10, 12, 15, 18, 20, 22, 25, 28 or 30, etc.), wherein an order of each repeating unit is arbitrary. In the present application, the silane coupling agent falls within the protection scope of the present application as long as it contains chain segments

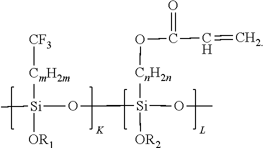

in formula (I); of course, the silane coupling agent can further contain other chain segments, wherein an order of each repeating unit is arbitrary.

In the present application, the silane coupling agent containing the structure shown in formula (I) has low dielectric loss, and its side chain contains a plurality of unsaturated bonds, which can increase the crosslink density of the inorganic filler and the resin containing unsaturated bonds at the interface between the inorganic filler and the resin, effectively preventing water molecules from infiltrating into the insulating layer through the interface between the inorganic filler and the resin during the HAST process to affect dielectric stability: in addition, the fluorine-containing groups on the side chain have good hydrophobicity, which can prevent the infiltrated water molecules from further binding with the resin, and is also helpful for dielectric stability. The insulating adhesive film prepared from the inorganic filler that has been subjected to surface treatment by the silane coupling agent containing the structure shown in formula (I) and the resin containing unsaturated bonds has excellent dielectric properties, good dielectric stability, and a small change amplitude of ΔD_{f} (10 GHZ) after HAST, which can be applied to high-frequency and high-speed printed circuit boards prepared by a semi-additive process or additive process.

Preferably, one molecule of the silane coupling agent containing the structure shown in formula (I) contains 3 to 30 fluorine atoms, such as 3, 6, 9, 12, 15, 18, 21, 24, 27 or 30, and specific point values between the above point values are also comprised, and for reasons of space and brevity, the specific point values comprised in the range will not be listed exhaustively in the present application.

Preferably, one molecule of the silane coupling agent containing the structure shown in formula (I) contains 2 to 10 acryloyloxy groups, such as 2, 3, 4, 5, 6, 7, 8, 9 or 10, and specific point values between the above point values are also comprised, and for reasons of space and brevity, the specific point values comprised in the range will not be listed exhaustively in the present application.

It should be noted that the inorganic filler can be subjected to surface treatment by using the silane coupling agent containing the structure shown in formula (I) by a conventional method in the prior art.

Exemplarily, a method for preparing the inorganic filler which is subjected to surface treatment by the silane coupling agent containing the structure shown in formula (I) comprises the following steps:

placing an inorganic filler in a mixer, spraying a silane coupling agent containing the structure shown in formula (I) into the inorganic filler at a stirring state, and reacting to obtain an inorganic filler which has been subjected to surface treatment by the silane coupling agent containing the structure shown in formula (I).

Based on a weight of the inorganic filler in the component (C) being 100%, the silane coupling agent has a content of 0.1-5%, such as 0.1%, 0.2%, 0.3%, 0.5%, 0.8%, 1%, 1.5%, 2%, 2.5%, 3%, 3.5%, 4%, 4.5% or 5%, and specific point values between the above point values are also comprised, and for reasons of space and brevity; the specific point values comprised in the range will not be listed exhaustively in the present application. If the content of the silane coupling agent containing the structure shown in formula (I) is too little, the surface treatment of the inorganic filler will not be enough, which cannot coat the inorganic filler well, resulting in a weak bridging effect between the inorganic filler and the unsaturated resin matrix; if the content of the silane coupling agent containing the structure shown in formula (I) is too much, the excess silane coupling agent will be free and migrate out, affecting the chemical copper binding force of the surface of the insulating adhesive film and reducing the dielectric properties of the insulating adhesive film at the same time.

Preferably, based on total parts by weight of the component (A) and the component (C) being 100%, a content of parts by weight of the component (C) is 30-80%, such as 30%, 35%, 40%, 45%, 50%, 55%, 60%, 70%, 75% or 80%, and specific point values between the above point values are also comprised, and for reasons of space and brevity, the specific point values comprised in the range will not be listed exhaustively in the present application. In the present application, more than or equal to 30 wt % of the high-filling component (C) are used to meet the performance requirements of the insulating adhesive film such as low CTE and low warpage; if the content of the component (C) is too low; the CTE and warpage resistance of the insulating adhesive film are poor, which is difficult to be applied to build up the insulating adhesive film: if the content of the component (C) is too high, the chemical copper binding force of the insulating adhesive film is reduced.

Preferably, based on total parts by weight of the component (A) and the component (C) being 100%, a content of parts by weight of the component (A) is 20-70%, such as 20%, 25%, 30%, 35%, 40%, 45%, 50%, 55%, 60%, 65% or 70%, and specific point values between the above point values are also comprised, and for reasons of space and brevity, the specific point values comprised in the range will not be listed exhaustively in the present application.

Preferably, parts by weight of the component (B) account for 0.1-5% of total parts by weight of the component (A) and the component (C), such as 0.1%, 0.2%, 0.3%, 0.5%, 0.8%, 1%, 1.5%, 2%, 2.5%, 3%, 3.5%, 4%, 4.5% or 5%, and specific point values between the above point values are also comprised, and for reasons of space and brevity, the specific point values comprised in the range will not be listed exhaustively in the present application.

Preferably, the inorganic filler in the component (C) comprises any one or a combination of at least two of silica, titanium dioxide, zinc oxide, aluminum hydroxide, aluminum oxide, magnesium oxide, magnesium hydroxide, calcium carbonate, aluminum nitride, boron nitride, aluminum silicon carbide, silicon carbide, zirconium oxide, mica, boehmite, calcined talc, talc, silicon nitride, strontium titanate, barium titanate or calcined kaolin.

Preferably, the silica can be any one or a combination of at least two of molten silica, crystalline silica, porous silica or hollow silica.

Preferably, the resin containing unsaturated bonds comprises any one or a combination of at least two of polyphenylene ether containing unsaturated bonds, a polyfunctional vinyl aromatic polymer, a styrene-butadiene-styrene polymer, a styrene-butadiene polymer, a styrene-isoprene polymer, polybutadiene, polyisoprene, a cyanate ester resin, an unsaturated cycloalkene copolymer, allyl-modified benzoxazine, triallyl isocyanurate, triallyl cyanurate or maleimide.

Preferably, the initiator comprises peroxide and/or an azo compound.

In a second aspect, the present application provides a resin varnish liquid, and the resin varnish liquid comprises the resin composition according to the first aspect and a solvent.

Preferably, the solvent comprises any one or a combination of at least two of acetone, butanone, methylethyl ketone, cyclohexanone, toluene or xylene.

In a third aspect, the present application provides an insulating adhesive film, and a material of the insulating adhesive film comprises the resin composition according to the first aspect.

The present application does not make specific restrictions on the method for preparing the insulating adhesive film, and exemplarily, a method for preparing the insulating adhesive film comprises the following steps:

mixing a resin composition with a solvent to obtain a resin varnish liquid, coating the resin varnish liquid on a base material, baking and removing the base material to obtain the insulating adhesive film.

Preferably, the base material comprises any one of polyethylene terephthalate, polyethylene naphthalate, polycarbonate, polymethyl methacrylate, cyclic polyolefin, triacetyl cellulose, polyether sulfide, polyether ketone, polyimide, polytetrafluoroethylene, polybenzimidazole, polyether ether ketone or any of polyphenylene sulfide.

Preferably, the base material has a thickness of 10-150 μm, such as 10 μm, 20 μm, 30 μm, 50 μm, 80 μm, 100 μm, 110 μm, 120 μm, 130 μm, 140 μm or 150 μm, and specific point values between the above point values are also comprised, and for reasons of space and brevity, the specific point values comprised in the range will not be listed exhaustively in the present application, further preferably 20-60 μm.

Preferably, the baking is performed at 80-120° C., such as 80° C., 90° C., 100° C., 110° C. or 120° C., and specific point values between the above point values are also comprised, and for reasons of space and brevity, the specific point values comprised in the range will not be listed exhaustively in the present application.

Preferably, the baking is performed for 1-10 min, such as 1 min, 3 min, 5 min, 8 min or 10 min, and specific point values between the above point values are also comprised, and for reasons of space and brevity, the specific point values comprised in the range will not be listed exhaustively in the present application.

Preferably, the insulating adhesive film has a thickness of 10-100 μm, such as 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm or 100 μm, and specific point values between the above point values are also comprised, and for reasons of space and brevity, the specific point values comprised in the range will not be listed exhaustively in the present application.

Preferably, a dielectric loss of the cured insulating adhesive film is less than or equal to 0.00261, such as 0.00208, 0.00220, 0.00245 or 0.00261, and specific point values between the above point values are also comprised, and for reasons of space and brevity, the specific point values comprised in the range will not be listed exhaustively in the present application.

Preferably, a ΔD_{f} (10 GHz) of the cured insulating adhesive film after HAST is less than or equal to 0.00015, such as 0.00010, 0.00012, 0.00014 or 0.00015, and specific point values between the above point values are also comprised, and for reasons of space and brevity, the specific point values comprised in the range will not be listed exhaustively in the present application.

Preferably, the insulating adhesive film after Desmear treatment has a surface roughness Ra value of less than or equal to 239 nm (for example, 152 nm, 161 nm, 173 nm or 239 nm, etc.), and a chemical copper binding force of more than or equal to 4.3 N/cm, such as 4.3 N/cm, 4.4 N/cm, 4.8 N/cm or 5.7 N/cm, and specific point values between the above point values are also comprised, and for reasons of space and brevity, the specific point values comprised in the range will not be listed exhaustively in the present application.

Compared with the prior art, the present application has the following beneficial effects.

(1) In the present application, the silane coupling agent containing the structure shown in formula (I) has low dielectric loss, and its side chain contains a plurality of unsaturated bonds, which can increase the crosslink density of the inorganic filler and the resin containing unsaturated bonds at the interface between the inorganic filler and resin, effectively preventing water molecules from infiltrating into the insulating layer through the interface between the inorganic filler and the resin during the HAST process to affect dielectric stability: in addition, the fluorine-containing groups on the side chain have good hydrophobicity, which can prevent the infiltrated water molecules from further binding with the resin, and is also helpful for dielectric stability.

(2) The insulating adhesive film prepared from the inorganic filler that has been subjected to surface treatment by the silane coupling agent containing the structure shown in formula (I) and the resin containing unsaturated bonds has excellent dielectric properties, good dielectric stability and a small change amplitude of ΔD_{f} (10 GHZ) after HAST, which can be applied to a high-frequency and high-speed printed circuit board prepared by a semi-additive process or additive process.

### DETAILED DESCRIPTION

The technical solutions of the present application are further explained by the following embodiments. It should be understood by those skilled in the art that the examples merely help to understand the present application, but should not be regarded as specific limitations of the present application.

Raw materials used in the preparation examples, comparative preparation examples, examples and comparative examples are as follows.

### (1) Resins Containing Unsaturated Bonds:

OPE-2st2200, polyphenylene ether containing a vinylbenzyl group at the end, Mitsubishi Chemical Corporation;
SA-9000, polyphenylene ether containing a methacrylate group at the end, SABIC;
B3000, polybutadiene resin, Soda Co., Ltd., Japan;
Ricon 100, styrene-butadiene copolymer, Sartomer, USA;
BMI-5100, bis(3-ethyl-5-methyl-4-maleimidophenyl) methane, Daiwa-Kasei Industry Co., Ltd.; and
ODV-XET (X05), polydivinylbenzene, Nippon Steel Chemical Industry Co., Ltd.

### (2) Initiators:

BPO: dibenzoyl peroxide, Yamato Oil Co., Ltd.; and
DCP: dicumyl peroxide, Shanghai Farida Chemical.

### (3) Inorganic Fillers:

SO-C2, silica with a median particle size D50 of 0.5 μm, Admatechs Co., Ltd., Japan; and
AO-502, aluminum oxide with a median particle size D50 of 0.7 μm, Admatechs Co., Ltd., Japan.

### (4) A Silane Coupling Agent Containing the Structure Shown in Formula (I), and the Molecule Contains Fluorine Atoms and Acryloyloxy Groups:

X-40-2430C, Shinetsu Chemical, Japan.

### (5) Other Silane Coupling Agents:

trifluoropropane trimethoxysilane, KBM-7103, Shinetsu Chemical, Japan, with a structural formula of

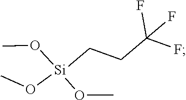

and
3-trimethoxysilane propyl acrylate, KBM-5103 Shinetsu Chemical, Japan, with a structural formula of

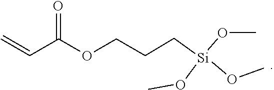

### Preparation Examples 1-6

Preparation Examples 1-6 respectively provide an inorganic filler which has been subjected to surface treatment by a silane coupling agent containing the structure shown in formula (I), and a preparation method comprises the following steps:

a formula amount of inorganic filler was placed in a mixer, and at a stirred state, a silane coupling agent containing the structure shown in formula (I) was sprayed into the inorganic filler and reacted for 10 min to obtain the inorganic filler which had been subjected to surface treatment by the silane coupling agent containing the structure shown in formula (I), which is respectively denoted as modified inorganic fillers A-F.

The specific selection and usage amount (parts by weight) of each component are shown in Table 1, wherein the “parts” and “parts by weight” involved in the present application are calculated by solid content but excluding solvents, dispersants, etc.

### Comparative Preparation Examples 1-3

Comparative Preparation Examples 1-3 differs from Preparation Example 1 only in that the silane coupling agent containing the structure shown in Formula (I) was replaced by other types of silane coupling agent with equal parts by weight, as shown in Table 1.

TABLE 1

| | | | | | | | | Comparative | Comparative | Comparative |
|---|---|---|---|---|---|---|---|---|---|---|
| | | Preparation | Preparation | Preparation | Preparation | Preparation | Preparation | Preparation | Preparation | Preparation |
| | | Example 1 | Example 2 | Example 3 | Example 4 | Example 5 | Example 6 | Example 1 | Example 2 | Example 3 |
| Inorganic | SO-C2 | 100 | | 100 | 100 | 100 | 100 | 100 | 100 | 100 |
| filler | AO-502 | | 100 | | | | | | | |
| Silane | X-40- | 2 | 3 | 0.1 | 5 | 0.05 | 6 | | | |
| coupling | 2430C | | | | | | | | | |
| agent | KBM- | | | | | | | 2 | | 1 |
| | 7103 | | | | | | | | | |
| | KBM- | | | | | | | | 2 | 1 |
| | 5103 | | | | | | | | | |

### Examples 1-6

Examples 1-6 respectively provide an insulating adhesive film, and a preparation method comprises the following steps:
a resin containing unsaturated bonds, an initiator and the inorganic filler obtained in the preparation examples which had been subjected to surface treatment by the silane coupling agent containing the structure shown in formula (I) were mixed according to the formula amount, a resin composition was obtained, added into a solvent (butanone) and stirred for 2 h, and a resin varnish liquid with a solid content of 65% was obtained; the resin varnish liquid was coated on a PET release film and baked in an oven at 120° C. for 5 min, and the insulating adhesive film was obtained.

The specific selection and usage amount (parts by weight) of each component are shown in Table 2.

TABLE 2

| | | Example | Example | Example | Example | Example | Example |
|---|---|---|---|---|---|---|---|
| | | 1 | 2 | 3 | 4 | 5 | 6 |
| Resin | OPE-2st 2200 | 50 | | | | | 40 |
| containing | SA-9000 | | 20 | 70 | | | |
| unsaturated | B3000 | | | | 50 | | |
| bonds | Ricon100 | | | | | 40 | |
| | BMI-5100 | | | | | 10 | |
| | ODV-XET (X05) | | | | | | 10 |
| Initiator | BPO | 1.5 | 0.5 | 2.0 | | | |
| | DCP | | | | 1.2 | 1.2 | 1.2 |
| Modified | A | 50 | | | | | |
| inorganic | B | | 80 | | | | |
| filler | C | | | 30 | | | |
| | D | | | | 50 | | |
| | E | | | | | 50 | |
| | F | | | | | | 50 |

### Comparative Example 1

This Comparative Example differs from Example 1 only in that the modified inorganic filler A was replaced by equal parts by weight of the modified inorganic filler prepared in Comparative Preparation Example 1.

### Comparative Example 2

This Comparative Example differs from Example 1 only in that the modified inorganic filler A was replaced by equal parts by weight of the modified inorganic filler prepared in Comparative Preparation Example 2.

### Comparative Example 3

This Comparative Example differs from Example 1 only in that the modified inorganic filler A was replaced by equal parts by weight of the modified inorganic filler prepared in Comparative Preparation Example 3.

### Comparative Example 4

This Comparative Example differs from Example 1 only in that the modified inorganic filler A was replaced by equal parts by weight of the inorganic filler and silane coupling agent (the inorganic filler SO-C2 and silane coupling agent X-40-2430C had a mass ratio of 100:2), that is, in this Comparative Example, a resin containing unsaturated bonds, an initiator, an inorganic filler and a silane coupling agent were directly mixed to obtain a resin composition, and other steps are the same as Example 1.

The performance of the insulating adhesive films prepared by Examples 1-6 and Comparative Example 1-4 are tested, and the test method is as follows:
(1) HAST: refer to JESD22-A110, highly accelerated temperature and humidity stress test (HAST) was performed at 130° C. and a humidity of 85% RH for 100 h;
(2) dielectric loss D_{f}: refer to IPC-TM-650 2.5.5.15, the dielectric loss D_{f} of the cured insulating adhesive film was measured by split post dielectric resonator method (SPDR) at 10 GHz;
(3) dielectric loss (D_{f}) after HAST: the above sample which had been tested for dielectric loss (D_{f}) was taken, and after HAST treatment, the dielectric loss (D_{f}) of the insulating adhesive film was measured by SPDR method at 10 GHz;
ΔD_{f} the dielectric loss (D_{f}) after HAST—the dielectric loss (D_{f}) before HAST:

### (4) Arithmetic Mean Value (Ra) of Roughness Profile:

the insulating adhesive film was laminated on the surface of a core board and cured in an oven at 180° C. for 30 min to obtain a pre-cured insulating adhesive film, and the insulating adhesive film was subject to the following Desmear treatment: the insulating adhesive film was soaked in an aqueous solution of glycol ethers and sodium hydroxide (MV Sweller, ATOTECH) at 70° C. for 10 min-washed with deionized water for 2 min—soaked in a potassium permanganate solution (MV P-Etch, ATOTECH) at 80° C. for 30 min—washed with deionized water for 2 min—soaked in an acid aqueous solution (MV Reduction Cleaner, ATOTECH) at 50° C. for 5 min to obtain a roughened insulating adhesive film, and the surface roughness Ra after roughening treatment was tested by using a laser confocal instrument (OLYMPUS); and

### (5) Chemical Copper Binding Force (PS):

the roughened insulating adhesive film was subject to the following copper precipitation, electroplating and post-curing: the roughened insulating adhesive film was soaked in chemical copper solution (MV TP1, ATOTECH) for 20 min-electroplated copper with a thickness of 25 μm-cured in an oven at 200° C. for 60 min, and the chemical copper binding force of the insulating adhesive film was tested by using a copper foil peel strength tester.

The performance test results of the examples and comparative examples are shown in Table 3.

TABLE 3

| | Dielectric | ΔD_{f} after | Ra (after | Chemical copper |
|---|---|---|---|---|
| | loss D_{f} | HAST | Desmear | binding force |
| | (10 GHz) | (10 GHz) | treatment)(nm) | (N/cm) |
| Example 1 | 0.00245 | 0.00014 | 173 | 4.8 |
| Example 2 | 0.00220 | 0.00015 | 239 | 5.7 |
| Example 3 | 0.00261 | 0.00010 | 152 | 4.4 |
| Example 4 | 0.00208 | 0.00012 | 161 | 4.3 |
| Example 5 | 0.00337 | 0.00044 | 295 | 6.6 |
| Example 6 | 0.00288 | 0.00053 | 207 | 3.7 |
| Comparative | 0.00256 | 0.00069 | 280 | 3.4 |
| Example 1 | | | | |
| Comparative | 0.00251 | 0.00052 | 145 | 4.4 |
| Example 2 | | | | |
| Comparative | 0.00248 | 0.00047 | 205 | 3.9 |
| Example 3 | | | | |
| Comparative | 0.00247 | 0.00027 | 160 | 3.6 |
| Example 4 | | | | |

As can be seen from Table 3, in Examples 1˜4 of the present application, the insulating adhesive film prepared from the inorganic filler that has been subjected to surface treatment by the silane coupling agent containing the structure shown in formula (I) and the resin containing unsaturated bonds has excellent dielectric properties, good dielectric stability, and a small change amplitude of ΔD_{f} (10 GHz) after HAST, wherein the dielectric loss D_{f} (10 GHz) is 0.00208-0.00261, the ΔD_{f} (10 GHz) after HAST is 0.00010-0.00015, the Ra (after Desmear treatment) is 152-239 nm, and the chemical copper binding force is 4.3-5.7 N/cm.

In Example 5, the content of the silane coupling agent containing the structure shown in formula (I) on the surface of the inorganic filler is low and cannot coat the inorganic filler well, resulting in a weak bridging effect between the inorganic filler and the unsaturated resin matrix, and the ΔD_{f} (10 GHz) after HAST is 0.00044, and meanwhile, the surface roughness Ra after Desmear treatment is large: in Example 6, the content of the silane coupling agent containing the structure shown in formula (I) on the surface of the inorganic filler is high, the excess silane coupling agent is free and migrate out, reducing the chemical copper binding force on the surface of the insulating adhesive film, and meanwhile, the ΔD_{f} (10 GHz) after HAST is 0.00053.

Compared with Example 1, the inorganic filler in Comparative Example 1 is subjected to surface modification by using a fluorine-containing silane coupling agent, and the surface of the inorganic filler is not crosslinked with the unsaturated resin matrix, wherein the hydrophobic fluorine-containing group can prevent the infiltrated water molecules from binding with resin to a certain extent, but the ΔD_{f} (10 GHz) after HAST is as high as 0.00069, and the Ra after Desmear treatment is also large, which is difficult to prepare fine circuits by the additive process; the inorganic filler in Comparative Example 2 is subjected to surface modification by using an acryloyloxy-containing silane coupling agent, though, which contains unsaturated bonds, the crosslinking between the surface of the inorganic filler and unsaturated resin matrix is little, and the ΔD_{f} (10 GHz) of the prepared insulating adhesive film after HAST is 0.00052; in Comparative Example 3, the fluorine-containing and acryloyloxy-containing silane coupling agents were used in combination, and the ΔD_{f} (10 GHz) of the prepared insulating adhesive film after HAST is 0.00047; in Comparative Example 4, the silane coupling agent is directly mixed into the resin composition, and through the dilution of the resin composition, the surface of the inorganic filler can only be coated with a trace amount of the silane coupling agent containing the structure shown in formula (I), resulting in a weak bridging effect between the surface of the inorganic filler and the unsaturated resin matrix, and the ΔD_{f} (10 GHZ) after HAST is 0.00027, and meanwhile, the chemical copper binding force is also reduced.

The applicant declares that the resin composition and its application of the present application are illustrated by the above examples. However, the present application is not limited to the above examples, which means that the present application does not necessarily rely on the above examples to be implemented. It should be understood by those skilled in the art that any improvement of the present application, the equivalent substitution of each raw material and the addition of auxiliary components and the selection of specific methods of the present application are within the scope of protection and disclosure of the present application.

What is claimed is:

1. A resin composition, wherein the resin composition comprises the following components: (A) a resin containing unsaturated bonds, (B) an initiator, and (C) an inorganic filler which has been subjected to surface treatment by a silane coupling agent;
the silane coupling agent contains a structure shown in formula (I): 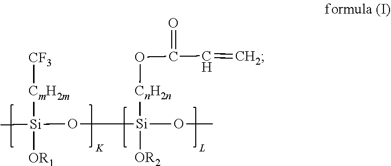
in formula (I), R₁ and R₂ are each independently selected from methyl or ethyl, m and n are each independently selected from integers from 1 to 4, and K and L are each independently selected from integers from 1 to 30, wherein an order of each repeating unit is arbitrary.

2. The resin composition according to claim 1, wherein one molecule of the silane coupling agent containing the structure shown in formula (I) contains 3 to 30 fluorine atoms.

3. The resin composition according to claim 1, wherein one molecule of the silane coupling agent containing the structure shown in formula (I) contains 2 to 10 acryloyloxy groups.

4. The resin composition according to claim 1, wherein based on a weight of the inorganic filler in the component (C) being 100%, the silane coupling agent has a content of 0.1-5%.

5. The resin composition according to claim 1, wherein based on total parts by weight of the component (A) and the component (C) being 100%, a content of parts by weight of the component (C) is 30-80%.

6. The resin composition according to claim 1, wherein based on total parts by weight of the component (A) and the component (C) being 100%, a content of parts by weight of the component (A) is 20-70%.

7. The resin composition according to any one of claim 1, wherein parts by weight of the component (B) account for 0.1-5% of total parts by weight of the component (A) and the component (C).

8. The resin composition according to claim 1, wherein the inorganic filler in the component (C) comprises any one or a combination of at least two of silica, titanium dioxide, zinc oxide, aluminum hydroxide, aluminum oxide, magnesium oxide, magnesium hydroxide, calcium carbonate, aluminum nitride, boron nitride, aluminum silicon carbide, silicon carbide, zirconium oxide, mica, boehmite, calcined talc, talc, silicon nitride, strontium titanate, barium titanate or calcined kaolin.

9. The resin composition according to claim 1, wherein the resin containing unsaturated bonds comprises any one or a combination of at least two of polyphenylene ether containing unsaturated bonds, a polyfunctional vinyl aromatic polymer, a styrene-butadiene-styrene polymer, a styrene-butadiene polymer, a styrene-isoprene polymer, poly butadiene, polyisoprene, a cyanate ester resin, an unsaturated cycloalkene copolymer, allyl-modified benzoxazine, triallyl isocyanurate, triallyl cyanurate or maleimide.

10. The resin composition according to claim 1, wherein the initiator comprises peroxide and/or an azo compound.

11. A resin varnish liquid, wherein the resin varnish liquid comprises the resin composition according to claim 1 and a solvent;

12. The resin varnish liquid according to claim 11, wherein the solvent comprises any one or a combination of at least two of acetone, butanone, methylethyl ketone, cyclohexanone, toluene or xylene.

13. An insulating adhesive film, wherein a material of the insulating adhesive film comprises the resin composition according to claim 1.

14. The insulating adhesive film according to claim 13, wherein the insulating adhesive film has a thickness of 10-100 μm.

15. The insulating adhesive film according to claim 13, wherein a dielectric loss of the cured insulating adhesive film is less than or equal to 0.00261.

16. The insulating adhesive film according to claim 13, wherein a ΔD_{f} (10 GHz) of the cured insulating adhesive film after HAST is less than or equal to 0.00015.

17. The insulating adhesive film according to claim 13, wherein the insulating adhesive film after Desmear treatment has a surface roughness Ra value of less than or equal to 239 nm and a chemical copper binding force of more than or equal to 4.3 N/cm.
